(19) United States
(12) Patent Application Publication
(10) Pub. No.: US 2014/0198018 A1
(43) Pub. Date: Jul. 17, 2014

(54) DISPLAY CONTROL DEVICE AND A DISPLAY CONTROL METHOD FOR MULTI-USER CONNECTION

(71) Applicant: TAIFATECH INC., Zhubei City (TW)

(72) Inventors: Kuo-Chung GAN, Zhubei City (TW); Chen-Chu SUNG, Zhubei City (TW)

(73) Assignee: TAIFATECH INC., Zhubei City (TW)

(21) Appl. No.: 13/800,494

(22) Filed: Mar. 13, 2013

(30) Foreign Application Priority Data
Jan. 11, 2013 (TW) 102101239

(51) Int. Cl. G06F 3/0488

(52) U.S. Cl. CPC G06F 3/0488
USPC 345/19; 345/173

(57) ABSTRACT

A display control device and a display control method for multi-user connection provides a control processing unit of a connection control module which executes a display application program to control a display unit for displaying a corresponding frame image. A plurality of mobile units are electrically connected to the connection control module via a wireless transmission interface, so the control processing unit of the connection control module controls the display unit to display the corresponding frame objects according to a connection of the mobile units. The control processing unit controls the display unit to display an interaction of the frame objects via input signals transmitted by the mobile units. Such invention allows multiple users to control the frame objects displayed by the display unit in the corresponding frame of a single display application program at the same time.

### BACKGROUND OF THE INVENTION

1. Field of the Invention

The present invention relates to a control circuit and a control method thereof, in particular to a display control device and a display control method for multi-user connection.

2. Description of the Related Art

According to the prosperity of the mobile telecommunication in the past few years, the first generation (1G) mobile telecommunication protocol are developed to the popularization of the third generation (3G) mobile telecommunication protocol today, even the popularization of the upcoming fourth generation (4G) mobile telecommunication protocol is developed for according with the mobile network of the mobile telecommunication protocol. Therefore, a mobile unit with mobile network changes continuously by generations in view of the development of the mobile telecommunication protocol. With regard to the operating technique, it is developed from the typical key control to the present touch technique nowadays. With regard to the display technique, it is developed from the prior monochromatic LCD technique to the current chromatic LCD technique and even the organic LED technique with active matrix nowadays. Therefore, the mobile unit steps to be simplified ceaselessly. The new designed mobile phones and tablet PCs are designed to be thinner and simpler on the appearance, such as iPhone, the mobile phone produced by Apple Inc., Butterfly, the mobile phone produced by HTC, iPad, the tablet PC produced by Apple Inc., and Surface, the tablet PC produced by Microsoft.

Since the related circuits of the display technique and the operating technique occupy less circuit dimension, the mobile unit accordingly occupies a larger circuit space for expanding the memory access space or the data memory space. Therefore, the smart mobile units capable of installing many kinds of applications (APP) are developed for users to execute the APP on the smart mobile units via mobile network connecting to the social network sites or the game servers in order to play games or have interactions with other users of other mobile units.

The development of the touch technique of the mobile units has reached a multi-touch period. However, there is still a problem unable to be executed effectively, namely the users from different mobile units cannot have an interaction therebetween, such as game racing and data exchanging, on a single medium platform at the same time, or the users cannot respectively connect to respective familiar websites for communicating on the single medium platform at the same time. Because the display dimension of the mobile unit is finite, the number of people sharing the same image is limited. Further, while the touch identification ability of the published mobile units is finite, the operational method of the mobile units still tends to be a single operation, which is unable to provide a multi-user operation at the same time. Being subject to the display dimension of the mobile unit and the touch and display functions executing on the same display image, the interaction between the user and others is limited and merely presented by an oral explanation and a frame demonstration of the individual operation but the multi-user operational interaction.

Therefore, the present invention provides a display control device and a display control method for multi-user connection which apply a plurality of mobile units connecting to a connection control module having uses in connection monitoring and displaying so as to control the display unit for displaying the corresponding frame objects and control the interactions of the frame objects via the connection control module.

### SUMMARY OF THE INVENTION

It is therefore the purpose of the present invention to provide a display control device and a display control method for multi-user connection, which makes use of the display control device for multi-user connection that provides users of a plurality of mobile units to join a multi-user connection at the same time.

It is therefore the further purpose of the present invention to provide a display control device and a display control method for multi-user connection which makes use of a concurrent multi-user connection to provide an interaction or games for the connection among multiple users at the same time.

To reach the mentioned purposes and efficiencies, the present invention discloses a display control device and a display control method for multi-user connection. The display control device comprises a connection control module and a display unit. The connection control module has a control processing unit. The connection control module is electrically connected to a plurality of mobile units via a wireless transmit interface. The connection control module is electrically connected to the display unit. The control processing unit is applied to execute a display application program and generate a corresponding display signal to the display unit for controlling the display unit to display a frame image. The control processing unit displays a plurality of corresponding frame objects in the frame image according to a connecting status of the mobile units.

The mobile units generate and transmit a plurality of input signals to the connection control module via the wireless transmit interface. The control processing unit generates a plurality of corresponding display control signals to the display unit in accordance with the input signals. The display unit displays an interaction of the frame objects in accordance with the display control signals. Therefore, users of the mobile units are able to interact via the frame objects controlled by each user and are not restricted to the display dimension of the mobile unit and the touch identification ability.

### BRIEF DESCRIPTION OF THE DRAWINGS

FIG. 1-A is a block diagram showing a preferred embodiment of the present invention;

FIG. 1-B is a block diagram showing a structure of a mobile unit of the present invention;

FIG. 2 is a schematic view showing a frame of the preferred embodiment of the present invention;

FIG. 3 is a schematic view showing a frame of another preferred embodiment of the present invention;

FIG. 4 is a schematic view showing a frame of another preferred embodiment of the present invention; and

FIG. 5 is a flow diagram showing the preferred embodiment of the present invention.

### DETAILED DESCRIPTION OF THE PREFERRED EMBODIMENTS

Before describing in detail, it should note that the like elements are denoted by the similar reference numerals throughout disclosure.

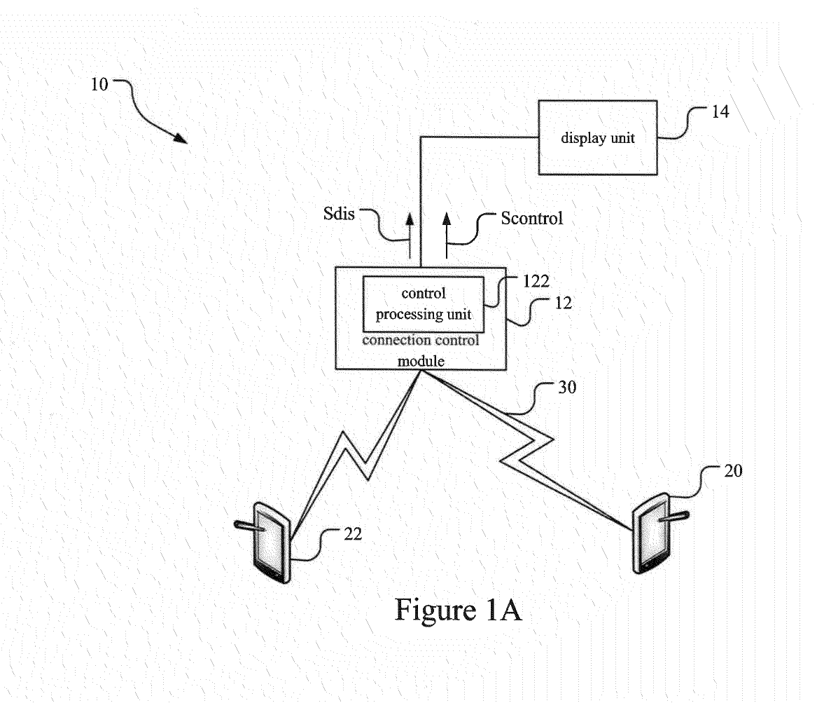

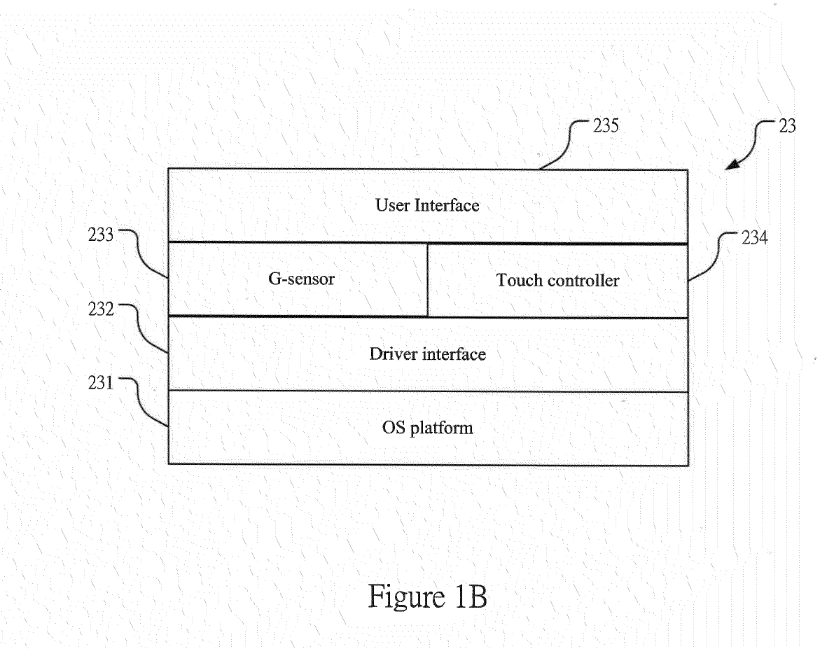

Referring to FIG. 1-A, a block diagram of a preferred embodiment of the present invention is shown. A display control device 10 of the present invention comprises a connection control module 12 and a display unit 14. The connection control module 12 has a control processing unit 122. The connection control module 12 of the display control device 10 is preferably electrically connected to a first mobile unit 20 and a second mobile unit 22. The connection control module 12 provides a connection for three users, four users, even over ten users, which is not limited to the embodiment scopes of the present invention. Herein, two mobile units 20, 22 are taken as an example in the preferred embodiment for simplifying the description of the present invention and allowing the examiner to easily understand the spirit thereof.

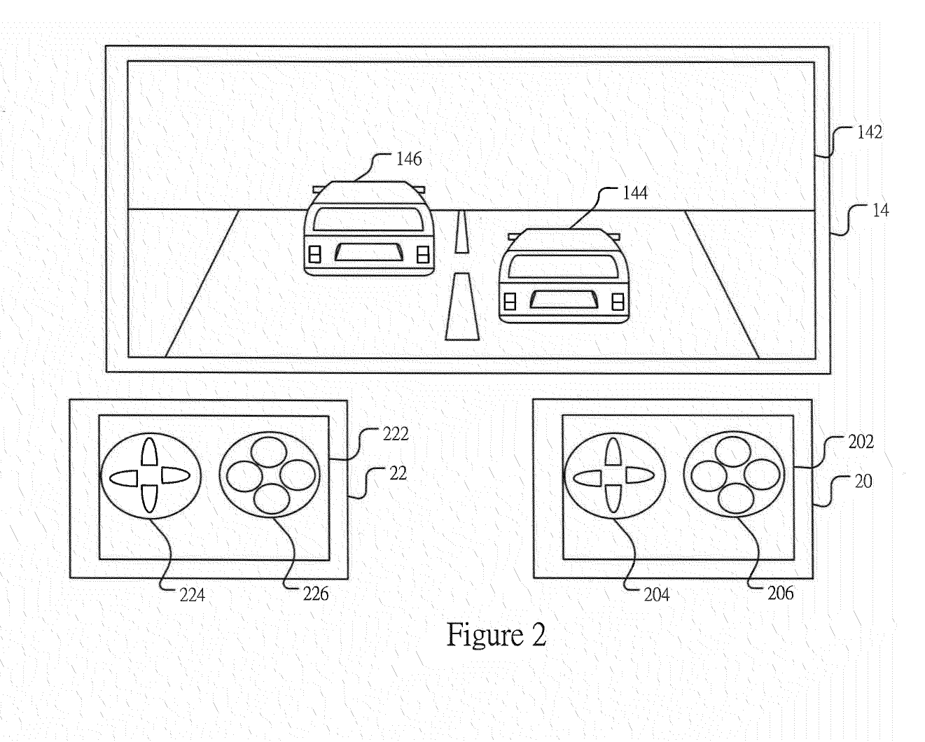

The connection control module 12 is electrically connected to the display unit 14. The control processing unit 122 of the connection control module 12 is applied to execute a display application program and correspondingly generate and transmit a display signal Sdis to the display unit 14, so the display unit 14 displays a frame image 142 according to the display signal Sdis (as shown in FIGS. 2 to 4). The two mobile units 20, 22 are connected to the connection control module 12 via a wireless transmit interface 30. The control processing unit 122 of the connection control module 12 identifies a connecting status of the two mobile units 20, 22 according to the addresses of the two mobile units 20, 22, and then controls the display unit 14 to display the two corresponding frame objects in the frame image 142 according to the connecting status of the two mobile units 20, 22, for example, the control processing unit 122 identifies the connecting status according to the IP addresses of the two mobile units 20, 22; or the control processing unit 122 identifies the connecting status according to the MAC addresses of the two mobile units 20, 22. The two mobile units 20, 22 transmit a plurality of input signals to the connection control module 12 via the wireless transmission interface 30. The control processing unit 122 of the connection control module 12 generates and transmits a corresponding display control signal Scontrol to the display unit 14 according to the input signals in order to control an interaction of the frame objects. A wireless transmission protocol followed by the wireless transmission interface 30 could be a RF protocol or an IrDA protocol. Further, the RF protocol could be a Bluetooth protocol or a Wireless Fidelity protocol (Wi-Fi protocol).

Referring to FIG. 1-B, a mobile unit structure 23 adopted from the mobile units 20, 22 of the preferred embodiment has an operating system platform 231, a driver interface 232, a gravity sensor 233, a touch sensor 234, and a user interface 235. The operating system platform 231 could be a mobile operating system such as IOS, Android, or Linux etc. The driver interface 232 is applied to match the operating system platform 231 with the gravity sensor 233 and the touch sensor 234 in order to provide the operating system platform 231 transferring a sense result of the gravity sensor 233 and the touch sensor 234 into input signals applied to be transmitted to the connection control module 12. The user interface 235 is applied to provide users to adjust a setting value of the gravity sensor 233 and the touch sensor 234 and provide an inputting interface for controlling the frame objects, for example, sliding on the touch screen and vibrating the mobile units 20, 22. In the preferred embodiment, the gravity sensor 233 and the touch sensor 234 are adopted as the sensors for sensing gestures from users of the mobile units 20, 22, thereby allowing the operating system platform 231 to correspondingly generate and transmit the input signals to the connection control module 12.

The control processing unit 122 of the connection control module 12 controls the display unit 14 to display a plurality of corresponding frame objects (a first frame object 144 and a second frame object 146 shown in FIG. 2) in the frame image 142 according to the connecting status of the mobile units 20, 22. That is to say, if one of the mobile units is not connected to the connection control module 12, the frame image 142 displayed by the display unit 14 will not display the corresponding frame object in the frame image 142. The frame objects could be a plurality of menus, a plurality of characters, or a plurality of cursor objects. The mobile units 20, 22 transmit the input signals to the connection control module 12 via the wireless transmission interface 30. The control processing unit 122 controls the interaction of the frame objects after computing and processing. The interaction of the frame objects includes switch motions or movements of the frame objects.

Referring to FIG. 2, a schematic view of the frame of the preferred embodiment of the present invention is shown. The frame image 142 displayed by the display unit 14 is shown in FIG. 2. Herein, the preferred embodiment only makes use of two mobile units 20, 22 in the description, so the frame image 142 displays only two frame objects 144, 146. A first frame object 144 is applied to correspond to the first mobile unit 20, and a second frame object 146 is applied to correspond to the second mobile unit 22. The frame image 142 described in the preferred embodiment is a car racing frame. Therefore, a first frame 202 of the first mobile unit 20 is applied to display a direction-control key module 204 and a functional key module 206. A second frame 222 of the second mobile unit 22 is applied to display a direction-control key module 224 and a functional key module 226. The aforementioned two frames respectively control the motions of the first frame object 144 and the second frame object 146 in the frame image 142, thereby providing a game interaction between users.

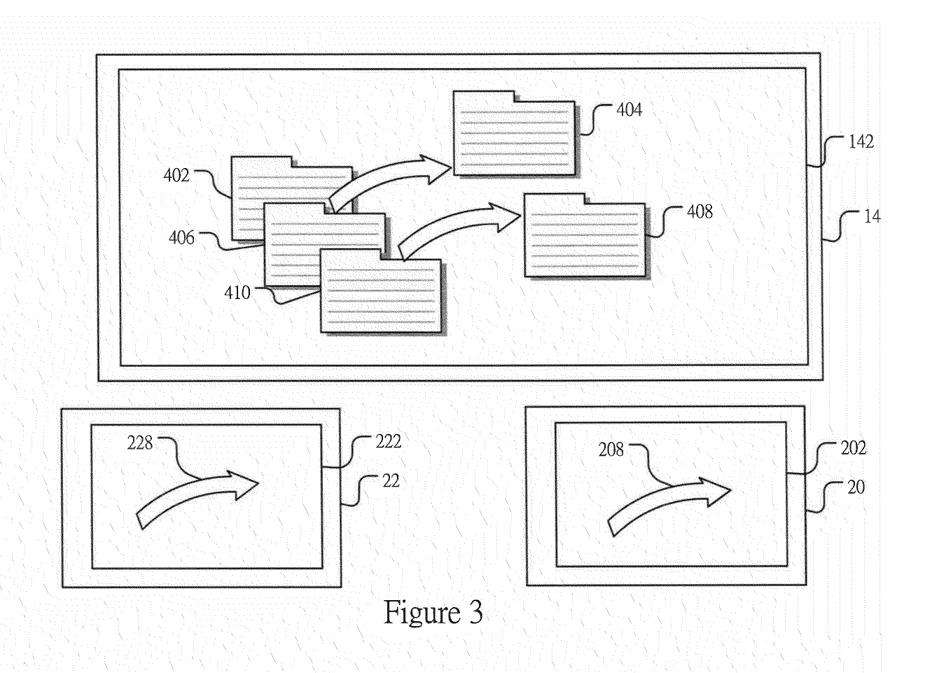

Referring to FIG. 3, a schematic view of another preferred embodiment of the present invention is shown. The frame image 142 displayed from the display unit 14 is a schematic view of the data exchanging. The frame image 142 refers to a first data 402 to a fifth data 410. The first frame 202 of the first mobile unit 20 is applied to show a first touch gesture 208, and the second frame 222 of the second mobile unit 22 is applied to show a second touch gesture 228. The first touch gesture 208 and the second touch gesture 228 are sensed via the touch sensor 234 as shown in FIG. 1-B, and then transferred into the corresponding input signals. The connection control module 12 computes and processes the input signals via the control processing unit 122 and generates the corresponding display control signal Scontrol for controlling the motions including data retrieval of the frame image 142 to be displayed by the display unit 14. The first touch gesture 208 is applied to retrieve a second data 404, and the second touch gesture 228 is applied to retrieve a fourth data 408, thereby providing the interaction among the users.

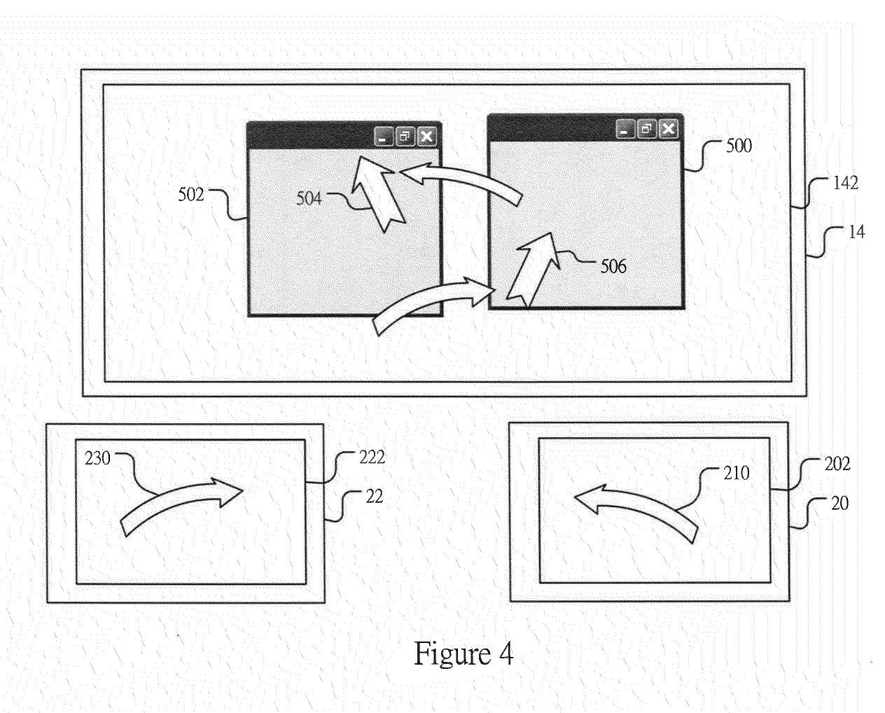

Referring to FIG. 4, a schematic view of a frame of another preferred embodiment of the present invention is shown. The frame image 142 refers to a plurality of windows 500, 502 and a plurality of mice 504, 506. The first frame 202 of the first mobile unit 20 shows a first touch gesture 210. The second frame 222 of the second mobile unit 22 shows a second touch gesture 230. The first touch gesture 210 and the second touch gesture 230 are sensed via the touch sensor 234 as shown in FIG. 1-B, and then transferred into the corresponding input signals. The control processing unit 122 of the connection control module 12 computes and processes the input signals and generates the corresponding display control signal Scontrol for controlling the motions including movements of the mouse of the frame image 142 to be displayed by the display unit 14. The first touch gesture 210 is applied to control the moving motions of the first mouse 504, and the second touch gesture 230 is applied to control the moving motions of the second mouse 506. Furthermore, the first touch gesture 210 and the second touch gesture 230 control the switch motions of the windows 500, 502, thereby providing the interactive operation among the users.

Thus, the mobile unit is able to display various user interface devices on the frame. The user can use the mentioned functions without buying extra user interface devices.

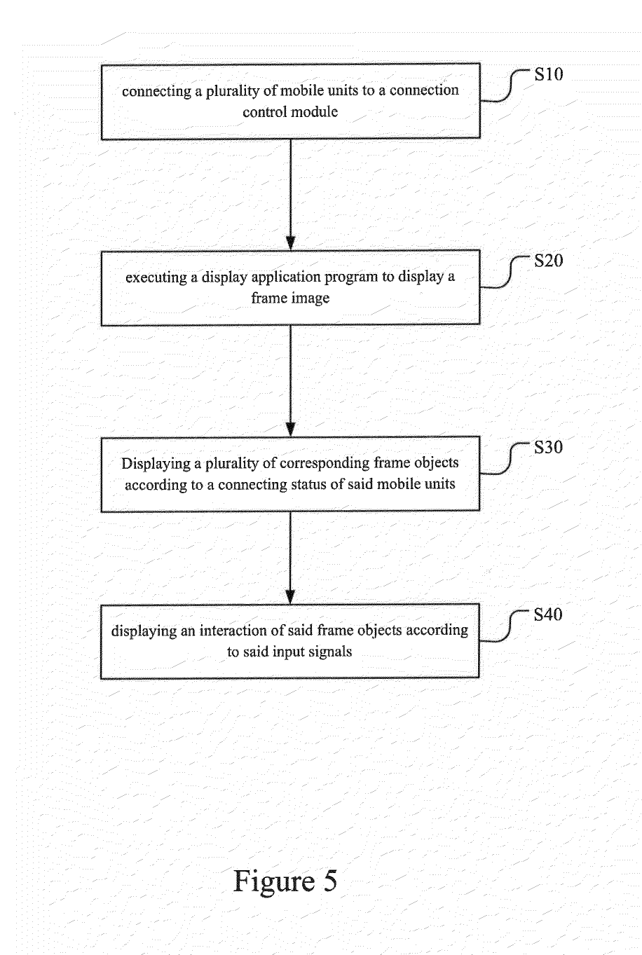

Referring to FIGS. 1-A, 1-B, and 5, a block diagram, a block diagram of the mobile unit structure, and a flow diagram of the preferred embodiment of the present invention are shown. Referring to FIG. 5, a display control method for multi-user connection comprises steps of:

Step S10: controlling a mobile unit to be connected to a connection control module;

Step S20: executing a display application program for displaying a corresponding frame image;

Step S30: displaying frame objects according to a connecting status of the mobile unit; and

Step S40: controlling an interaction of the frame objects.

In the step S10, the user controls a first mobile unit 20 and a second mobile unit 22 to be connected to a connection control module 12 via a wireless transmission interface 30. A wireless transmission protocol followed by the wireless transmission interface 30 could be a RF protocol or an IrDA protocol. The RF protocol could be a Bluetooth protocol or a Wireless Fidelity protocol (Wi-Fi protocol). The connection control module 12 processes the input signals of the mobile units 20, 22 via a control processing unit 122 so as to correspondingly generate and transmit the display control signals to the display unit 14. In the step S20, the control processing unit 122 of the connection control module 12 is applied to execute a display application program for controlling a display unit 14 to display a frame image 142. In the step S30, the control processing unit 122 of the connection control module 12 identifies the connecting status of the mobile units 20, 22 according to the addresses of the mobile unit 20, 22, so the control processing unit 122 controls the display unit 14 to display the corresponding frame objects in the frame image 142 according to the connecting status of the mobile units 20, 22. In the step S40, the user inputs a plurality of input signals to the connection control module 12 via the mobile units 20, 22, and the control processing unit 122 controls the display unit 14 to display the interaction of the frame objects by processing the input signals. The frame objects could be a plurality of menus, a plurality of characters, or a plurality of cursor objects. The interaction of the frame objects includes switch motions or movements of the frame objects. The mobile units 20, 22 respectively sense the user gestures of the mobile units 20, 22 by at least one sensor so as to correspondingly generate and transmit the input signals to the connection control module 12.

The aforementioned preferred embodiments are meant to reduce the unnecessary details in the operation of the mobile units, so it takes only two mobile units 20, 22 as an example. It is noted that the connection control module 12 of the present invention is not subject to only two mobile units 20, 22. The connection for more mobile units can be applied to the connection control module 12 of the present invention in accordance with the using demand.

From the foregoing description, users of a plurality of mobile units are able to play or communicate in the same frame via the connection control module at the same time. Because the mobile units display various user interface devices on the frame, the users are able to use various functions without buying extra user interface devices.

To sum up, a display control device and a display control method for multi-user connection of the present invention allows users to connect a plurality of mobile units to a connection control module via a wireless transmission interface and applies the connection control module to execute a display application program for displaying a corresponding frame image and frame objects corresponding to the mobile units. The connection control module receives input signals from the mobile units so as to control the display unit to display motions of the corresponding frame objects. Therefore, the present invention provides an intercommunication platform for users with multiple mobile units, thereby having fun together without being limited to frames on respective mobile units. Moreover, the users do not have to buy a new user interface device for meeting various using demands.

While we have shown and described the embodiment in accordance with the present invention, it should be clear to those skilled in the art that further embodiments may be made without departing from the scope of the present invention.

I claim:

1. A display control device for multi-user connection comprising:
a connection control module having a control processing unit; said control processing unit executing a display application program for generating a display signal; said connection control module being connected to a plurality of mobile units via a wireless transmission interface; and
a display unit electrically connected to said connection control module and displayed a frame image in accordance with said display signal; said control processing unit controlling said display unit to display a plurality of corresponding frame objects in said image according to a connecting status of said mobile units;
wherein, said mobile units generate and transmit a plurality of input signals to said connection control module via said wireless transmission interface; said control processing unit generating a plurality of display control signals to said display unit in accordance with said input signals; said display unit displaying an interaction of said frame objects according to said display control signals.

2. The display control device for multi-user connection as claimed in claim 1, wherein said connection control module is built in said display unit; said control processing unit identifies said connecting status of said mobile units in accordance with a plurality of addresses of said mobile units.

3. The display control device for multi-user connection as claimed in claim 1, wherein said frame objects are a plurality of menus, a plurality of characters, or a plurality of cursor objects; said interaction of said frame objects includes switch motions or movements of said frame objects.

4. The display control device for multi-user connection as claimed in claim 1, wherein a plurality of sensors are disposed on said mobile units for sensing gestures of users of said mobile units so as to correspondingly generate and transmit said input signals to said connection control module.

5. The display control device for multi-user connection as claimed in claim 1, wherein said mobile units include a plurality of frames; said frames display a plurality of control interfaces; said control interfaces are a plurality of key modules or touch gestures.

6. A display control method for multi-user connection comprising steps of:
connecting a plurality of mobile units to a connection control module via a wireless transmission interface; said connection control module having a control processing unit for processing a plurality of input signals of said mobile units;
executing a display application program by said control processing unit for controlling a display unit to display a frame image;
displaying a plurality of corresponding frame objects in said frame image according to a connecting status of said mobile units; and
controlling said display unit for displaying an interaction of said frame objects according to said input signals.

7. The display control method for multi-user connection as claimed in claim 6, wherein said connection control module is built in said display unit; said control processing unit identifies said connecting status of said mobile units according to a plurality of addresses of said mobile units.

8. The display control method for multi-user connection as claimed in claim 6, wherein said frame objects are a plurality of menus, a plurality of characters, or a plurality of cursor objects; said interaction of said frame objects includes switch motions or movements of said frame objects.

9. The display control method for multi-user connection as claimed in claim 6, wherein in said step of inputting said input signals to said connection control module, said mobile units applies at least one sensor respectively to sense gestures of users of said mobile units in order to correspondingly generate and transmit said input signals to said connection control module.

10. The display control method for multi-user connection as claimed in claim 6, wherein said mobile units have a plurality of frames; said frames display a plurality of control interfaces; said control interfaces are a plurality of key modules or touch gestures.
